(19) United States
(12) Patent Application Publication
(10) Pub. No.: US 2017/0234208 A1
(43) Pub. Date: Aug. 17, 2017

(54) Multiple Intake Air Coolers Arranged in Parallel

(71) Applicant: Ford Global Technologies, LLC, Dearborn, MI (US)

(72) Inventor: Gary Nola, Detroit, MI (US)

(21) Appl. No.: 15/042,003

(22) Filed: Feb. 11, 2016

(51) Int. Cl. F02B 29/04; F02M 35/10

(52) U.S. Cl. CPC F02B 29/0412; F02B 29/0437; F02M 35/10242; F02B 29/0425

(57) ABSTRACT

Charge air coolers (CACs) are commonly used in pressure-charged, internal combustion engines to reduce the temperature of the air entering the combustion chamber. Typically, one CAC is provided and all of the intake air is inducted past the one CAC. An intake manifold in which a plurality of CACs are provided in the intake runners, i.e., a parallel flow arrangement, is disclosed herein. By positioning the CACs in the intake runners, the CACs are more effective than when they are positioned upstream in the plenum. In some embodiments, the coolant is supplied and returned to the multiple CACs via headers. By providing coolant to each CAC that is substantially the same temperature, the cylinder-to-cylinder temperature variation is reduced compared to a single CAC.

### FIELD

The present disclosure relates to charge air coolers in the intake system of an internal combustion engine.

### BACKGROUND

It is known to use charge air coolers (CACs) to cool down intake air that has been heated by a pressure charger, such as a turbocharger or supercharger. The power that can be developed by the engine is related to the amount of air that can be inducted into the cylinder. The colder the air, the denser the air, and consequently a greater amount of fuel can be burned in the cylinder thereby generating greater power. Additionally, having cooler air helps to resist engine knock or auto-ignition in a spark-ignition engine. Also, the lower the in-cylinder temperature due to the air being cooler, the less NOx that is formed during the combustion event.

In one prior art system, a CAC 16 is placed in a plenum of an intake manifold 10. Manifold 10 has an upper shell 12 and a lower shell 14 which forms a plenum 18 that houses CAC 16. Manifold 10 has a plurality of runners, a lower part 20 and an upper part 22 that are formed when upper shell 12 and lower shell 14 are affixed via friction welding or any other suitable process. A gasket 24 is provided between CAC 16 and upper and lower shells 12 and 14 to prevent intake air from shortcircuiting CAC 16. One shortcoming of such a configuration is that the coolant in the CAC proximate some cylinders is cooler than that in other cylinders leading to cylinder-to-cylinder variability in temperature. Also, because the intake manifold is heated by being under the hood of the vehicle, the air that is cooled in the plenum heats up during transit through the runners.

### SUMMARY

The inventor of the present disclosure has recognized that the effectiveness of the charge air cooler (CAC) is increased the closer that the CAC is located to the combustion chamber of the engine. An intake manifold that moves the CAC closer to the combustion chamber of an engine is disclosed. The manifold has an entrance, a plurality of intake runners, a plenum fluidly coupled to the intake runners, and a charger air cooler disposed in each of the intake runners.

The charge air coolers are placed in a downstream end of the intake runners.

Each charge air cooler has a plurality of heat exchange tubes located within the intake runners for conducting a cooling fluid therethrough.

The heat exchange tubes are coupled on an upstream end to a cooling fluid supply header and the heat exchange tubes are coupled on a downstream end to a cooling fluid return header.

A supply orifice and a return orifice are defined through the walls of each of the intake runners. The supply orifices allow a supply of cooling fluid to enter the charge air cooler and the return orifices allow a return of cooling fluid to leave the charge air cooler.

The charge air coolers are placed in an upstream end of the intake runners. In some embodiments, the charge air coolers are inserted in the intake runners prior to assembling the intake manifold.

The coolant is one of: water, a water and ethylene glycol mixture, and air.

The intake runners have a greater cross-sectional area along the length of the runners where the charge air coolers are inserted than along the length of the runners without a charge air cooler installed therein.

The charge air coolers are tube heat exchangers. Tubes of the tube heat exchangers obstruct a portion of the cross section of the runners. To overcome a drop in cross sectional area, a cross-sectional area of the runners is enlarged where the charge air coolers are provided.

Also disclosed is a method to assemble an intake manifold, including: fabricating a first portion of an intake manifold, fabricating a second portion of the intake manifold wherein the second portion includes a plurality of intake runners, inserting a charge air cooler into each of the intake runners, and affixing the first and second portions of the intake manifold.

In some embodiments, the charge air coolers are placed in an upstream end of the intake runners. Alternatively, they are place in a downstream end or along the length of the intake runners.

The method may further include coupling a coolant supply tube to an upstream end of each of the charge air coolers and coupling a coolant return tube to a downstream end of each of the charge air coolers.

The coolant supply tubes are coupled on an upstream end to a coolant supply header and the coolant return tubes are coupled on a downstream end to a coolant return header.

Also disclosed is, an intake manifold for an internal combustion engine having a first intake manifold section having an entrance and a plenum, a second intake manifold section having a plurality of runners adapted to couple to intake ports of the engine, a charge air cooler disposed in each of the runners, and a coolant supply and a coolant return coupled to each of the charge air coolers.

The manifold may further include a coolant supply header coupled to each of the coolant supplies and a coolant return header coupled to each of the coolant returns.

In some embodiments, the runners are of a greater cross-section along the length of the runners in which the charge air coolers are disposed compared to the runners without the charge air coolers.

The charge air coolers are heat exchangers that have a plurality of tubes disposed therein with intake air passing across outside surfaces of the tubes and coolant flowing through the tubes. The coolant is a water-based coolant in some embodiments and air in others.

By providing coolant to each CAC that is nearly the same temperature, the temperature of the air provided to each of the cylinders is nearly same, which presents an advantage of the prior art solution of having a single CAC. Furthermore, the air provided to the cylinders is cooler than it would otherwise be when the CAC is in the plenum. That is particularly the case for the CAC at the downstream end of the intake runner.

### BRIEF DESCRIPTION OF THE DRAWINGS

FIG. 1 is an illustration of a prior art intake manifold in which a single charge air cooler is placed in the plenum;

FIG. 2 is an illustration of a V8 engine having two intake manifolds;

FIGS. 3 and 4 are illustrations of an intake manifold with charge air coolers in the runner in downstream and upstream positions, respectively;

FIG. 5 is an illustration of a runner with a greater cross-section along the length where the charge are cooler is provided; and

FIG. 6 is a side view of a single runner of an intake manifold that has a CAC disposed there.

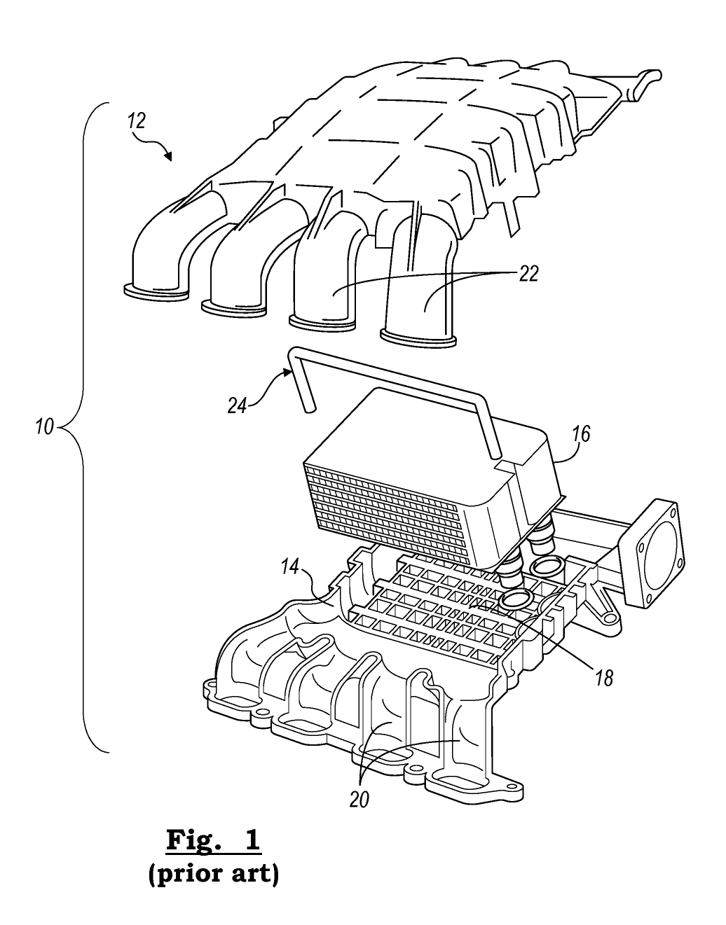

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

In FIG. 2, an engine 200 is shown that has an engine block 212 having first cylinder bank 214 and a second cylinder bank 216. Engine 200 includes first and second cylinder heads 214, 216 that define the upper portion of cylinders 222 and contain various intake, exhaust, and cooling passages. Fuel injectors 220 are secured within a respective cylinder head and extends into a respective cylinder of engine 200. A fuel pump 228 that is driven off the engine camshaft (not shown) provides the high pressure fuel to injectors 220. Exhaust manifolds 230, 232 are disposed on the inboard side of an associated cylinder head and connects exhaust passages from cylinders 222 with a corresponding bank 214, 216 to a turbine of a turbocharger 242. The compressor section of turbocharger 242 is connected to an intake system 244 disposed generally on the outboard side of cylinder banks 214, 216. Intake manifolds 246, 248 distribute intake air to each of the various cylinders from the outboard side of engine 200.

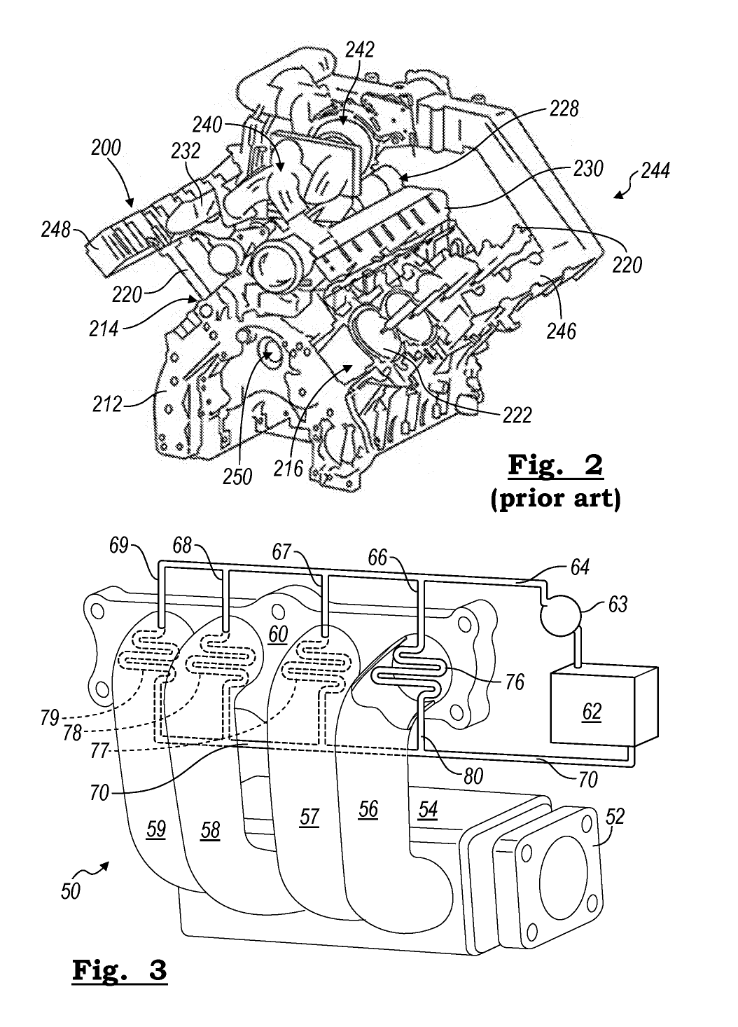

In FIG. 3, a manifold system 50 to feed air to four cylinders of an engine is shown. Air is provided from a throttle body through flange 52 in a plenum 54. Plenum 54 leads to intake runners 56, 57, 58, and 59. Runners 56, 57, 58, and 59 are coupled together, mechanically, but not fluidly, via flange 6o that bolts to a cylinder head (not shown). Runner 56 is cutaway at its downstream end to show a charge air cooler (CAC) 76 that is provided within runner 56. Runners 57, 58, and 59 also have CACs 77, 78, and 79, respectively, which are hidden from view, but the areas in which they reside are shown by dotted lines on the runners. Fluid circulates to and from a radiator 62 via a pump 63 to provide cooled fluid through CACs 76, 77, 78, and 79. Fluid flows from radiator 62 to inlet header 64 and then branches to CACs 76, 77, 78, and 79 via branches 66, 67, 68, and 69, respectively. An outlet header 70 receives fluid from the CACS via branches, which are mostly not visible in FIG. 3. Only branch 80 from CAD 76 is visible. In alternative configuration, the flow could leave radiator 62 into header 70 and then returned to radiator 62 through header 64, in which case element 70 is an inlet header and element 64 is an outlet header.

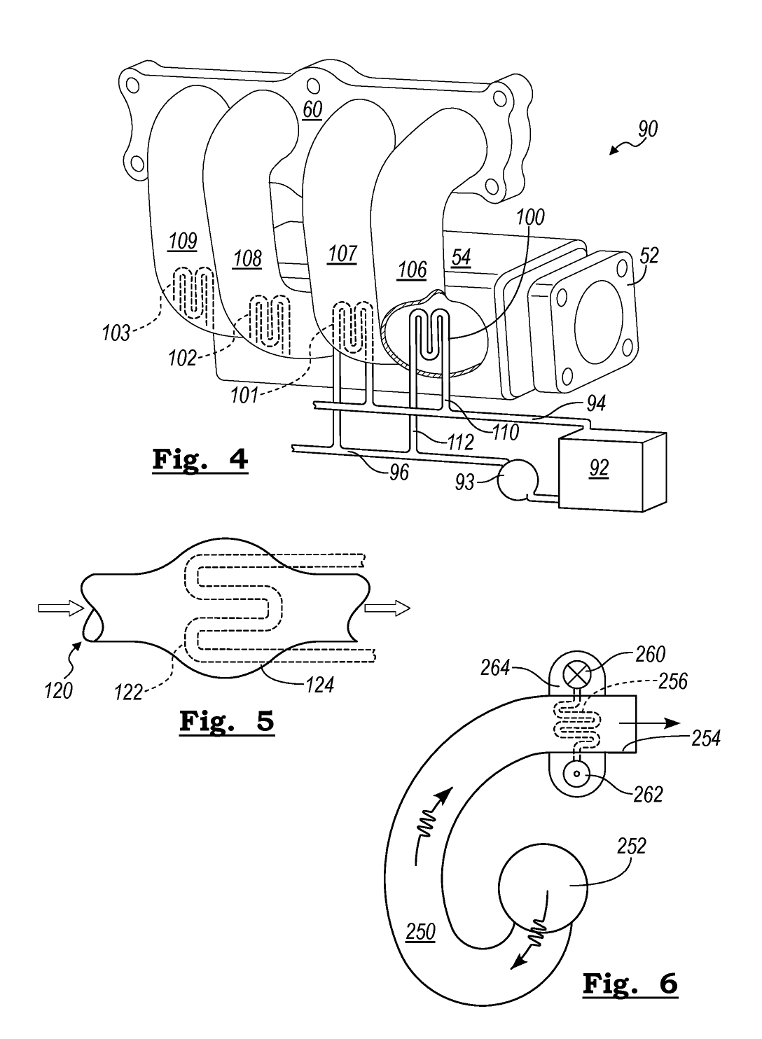

An alternative configuration is shown in FIG. 4 in which an intake manifold system 90 has CACs provided at the upstream end of the runners. Runners 106, 107, 108, and 109 through when intake air flow to an engine (not shown) have CACs 100, 101, 102, and 103, respectively, disposed therein. Runner 106 is cutaway so that CAC 100 can be viewed as well as the connections to a branch 110 that fluidly couples with header 94 and a branch 112 that fluidly couples with header 96. Headers 94 and 96 are each fluidly coupled to a radiator 92. Flow through the cooling circuit, which includes CACs 100, 101, 102, 103, headers 94, 96, radiator 92, and branches between each of the CACs and the headers, is provided by a pump 93 that is disposed in header 96. Depending on the type of pump and the direction of flow, pump 93 could alternatively be disposed in header 94.

The CAC presents some obstruction to the flow. Thus, in some embodiments, the cross-sectional area of the runner may be increased so that the cross-sectional area available for air flow is not significantly impaired. A small portion of a runner 120 houses a CAC in a section 122 as shown in FIG. 5. Runner 120 has a bulge along the length 124 of runner 120 so that airflow to the engine is not noticeably impaired by the obstruction of the CAC within runner 120. If the CAC is made of a flexible tubing, the CAC can be squeezed into the small end of the runner and allowed to expand after insertion into the length of the runner with the bulge. In other embodiments, the CAC is installed in the upstream end of the runner where it meets the runner so that the runner starts at the larger diameter and decreases downstream of the CAC.

In FIG. 6, a single runner 250 is shown in cross section. Runner 250 has an inlet 252 from a plenum (not shown) and an outlet 254 to a port of an engine. A CAC 256 is provided with runner 250 near the downstream end of runner 250. Coolant is supplied to CAC 256 via headers 260 and 262 that run through a block 264 that in one embodiment is formed with runner 250.

The CACs shown in FIGS. 3 and 4 are a single tube that is bent back and forth. Many known heat exchangers are manifolds themselves in which a single inlet line branches into multiple tubes and then those multiple branches are collected into a single outlet line. That alternative could be employed for any of the CACs shown herein.

The fluid pumped through the CAC can be a liquid, such as engine coolant, or a gas, such as ambient air. An appropriate pump for the state of the fluid is provided. In some embodiments, the cooling system for the CAC is not solely for that purpose, but may be coupled with another cooling system on a vehicle, such as the engine cooling system. The engine coolant to the CAC could be cooled by the engine's radiator or have a separate radiator for the CAC that bring the temperature of the coolant to a lower temperature than might be used for cooling the engine.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. An intake manifold for an internal combustion engine, comprising:
an entrance;
a plurality of intake runners;
a plenum fluidly coupled to the entrance and to the intake runners; and
a charge air cooler disposed in each of the intake runners.

2. The intake manifold of claim 1 wherein the charge air coolers are placed in a downstream end of the intake runners.

3. The intake manifold of claim 1 wherein each charge air cooler comprises a plurality of heat exchange tubes located within the intake runners for conducting a cooling fluid therethrough.

4. The intake manifold of claim 3 wherein the heat exchange tubes are coupled on an upstream end to a cooling fluid supply header and the heat exchange tubes are coupled on a downstream end to a cooling fluid return header.

5. The intake manifold of claim 4 wherein a supply orifice and a return orifice are defined through the walls of each of the intake runners, the supply orifices allowing a supply of cooling fluid to enter the charge air cooler and the return orifices allowing a return of cooling fluid to leave the charge air cooler.

6. The intake manifold of claim 1 wherein the charge air coolers are placed in an upstream end of the intake runners; and the charge air coolers are inserted in the intake runners prior to assembling the intake manifold.

7. The intake manifold of claim 1 wherein the coolant is one of: water, a water and ethylene glycol mixture, and air.

8. The intake manifold of claim 1 wherein the intake runners have a greater cross-sectional area along the length of the runners where the charge air coolers are inserted than along the length of the runners without a charge air cooler installed therein.

9. The intake manifold of claim 1 wherein:
the charge air coolers are tube heat exchangers;
tubes of the tube heat exchangers obstruct a portion of the cross section of the runners; and
a cross-sectional area of the runners is enlarged where the charge air coolers are provided.

10. A method to assemble an intake manifold, comprising:
fabricating a first portion of an intake manifold;
fabricating a second portion of the intake manifold wherein the second portion includes a plurality of intake runners;
inserting a charge air cooler into each of the intake runners; and
affixing the first and second portions of the intake manifold.

11. The method of claim 10 wherein the charge air coolers are placed in an upstream end of the intake runners.

12. The method of claim 10 wherein the charge air coolers are placed in a downstream end of the intake runners.

13. The method of claim 10, further comprising:
coupling a coolant supply tube to an upstream end of each of the charge air coolers; and
coupling a coolant return tube to a downstream end of each of the charge air coolers.

14. The method of claim 10 wherein the coolant supply tubes are coupled on an upstream end to a coolant supply header and the coolant return tubes are coupled on a downstream end to a coolant return header.

15. An intake manifold for an internal combustion engine, comprising:
a first intake manifold section having an entrance and a plenum;
a second intake manifold section having a plurality of runners adapted to couple to intake ports of the engine;
a charge air cooler disposed in each of the runners; and
a coolant supply and a coolant return coupled to each of the charge air coolers.

16. The intake manifold of claim 15, further comprising:
a coolant supply header coupled to each of the coolant supplies; and
a coolant return header coupled to each of the coolant returns.

17. The intake manifold of claim 15 wherein the runners are of a greater cross-section along the length of the runners in which the charge air coolers are disposed compared to the runners without the charge air coolers.

18. The intake manifold of claim 15 wherein the charge air coolers are heat exchangers that have a plurality of tubes disposed therein with intake air passing across outside surfaces of the tubes and coolant flowing through the tubes.

19. The intake manifold of claim 15 wherein the coolant is one of air and a water-based coolant.

20. The intake manifold of claim 15 wherein the charge air coolers are disposed in the downstream end of the runners.
